(19) United States
(12) Patent Application Publication
(10) Pub. No.: US 2020/0265373 A1
(43) Pub. Date: Aug. 20, 2020

(54) ONLINE OPEN DELIVERY SYSTEM

(71) Applicant: Kwon Suk KOH, Songpa-gu, Seoul (KR)

(72) Inventor: Kwon Suk KOH, Songpa-gu, Seoul (KR)

(21) Appl. No.: 16/762,144

(22) PCT Filed: Oct. 29, 2018
(86) PCT No.: PCT/KR2018/012953

§ 371 Date: May 7, 2020

(30) Foreign Application Priority Data
Nov. 15, 2017 (KR) 10-2017-0152401

(51) Int. Cl. G06Q 10/08; G06Q 30/06

(52) U.S. Cl. CPC G06Q 10/083; G06Q 30/0617

(57) ABSTRACT

Summary

The present invention provides information of a plurality of online shopping malls and Delivery Company subscribed as members through a web site, and provides the address information of the domestic or foreign countries registered by the delivery company and the delivery charge information according to the delivery zone information, the delivery methods information and the point information in website.

The present invention includes the following; the delivery management server for delivering goods purchased at a specific online shopping mall by the orderer to the delivery address through the delivery company selected by the seller or manager at the online shopping mall; and orderer terminal that select and input the address information to receive the product from selected delivery company based on the delivery zone information after performs product select in any one among of a plurality of online shopping malls provided by the delivery management server, delivery methods select provided by the delivery management server, and purchase payment or delivery payment about goods or the delivery company as terminal used by the orderer.

### TECHNICAL FIELD

One embodiment of the present invention is relates to an online open delivery system.

### BACKGROUND TECHNOLOGY

Currently online shops are operated in various forms. For example, there are forms of open market or internet shopping mall form through internet, or the TV home shopping form through terrestrial broadcasting or cable broadcasting, or the catalog sales' forms that receive goods order information in the list of catalog after catalogs is sent to customers and send the goods. In this specification, a shopping mall should be understood as including various types of sales forms.

Open market or internet shopping mall is a virtual shop to buy and sell goods using the Internet. Internet shopping mall has no time/space and border limitations compared with traditional markets. Consumers can purchase goods as relatively low prices anywhere anytime at virtual stores around the world opened on the Internet. From viewpoint of operator, online shop has very little operating cost and is not restricted by business district, and can provide goods information that matches the consumer's taste.

Delivery system can be classified into two categories in online shops including open market. For example, as a method called “delivery method of shopping mall”, online shop's operator receives goods from seller (call “partner” or “vendor”) and delivers them to buyer, or shopping mall's operator sends the buyer's order information to the delivery company, and then the delivery company directly receives the goods from the seller and delivers the goods to the buyer. Another example, as a method called “seller delivery directly”, seller who received buyer's order information from the shopping mall's operator directly contacts delivery company and delivers the goods to buyer.

In the case of seller delivery among the above two methods, shopping mall's operator displays the delivery status on the shopping mall homepage depending on delivery information entered by seller (key-in completed). Therefore, if the seller inputs that the goods are already shipped without actually shipping the goods, the buyer could have assumed that the goods delivery had already begun. These problems have caused buyer's complain about delayed delivery to the shopping mall side.

If there is a problem about delivery, there is a problem that it is difficult to intervene at the shopping mall side to solve the problem because each seller has contracted individually with each delivery company.

### DETAILED DESCRIPTION OF THE INVENTION

### Technical Challenge

One embodiment of the present invention provides an online open delivery system for delivering goods of online shopping mall through the delivery company selected by the orderer.

### Solution to Problem

Online open delivery system according to an embodiment of the present invention provides information of a plurality of online shopping malls and Delivery Company registered as members through a website and provides the address information of domestic or foreign countries (Hereinafter, delivery zone information), the delivery charge information according to the delivery zone information, information of delivery methods and point information registered by the delivery company on the website.

Online open delivery system that includes; Delivery management server that deliver goods purchased at a specific online shopping mall by orderer (company or individual) to the destination through the delivery company selected by seller or manager at the online shopping mall; and performs goods selection in any one among a plurality of online shopping malls provided by the delivery management server, delivery methods selection provided by the delivery management server and the purchase payment or delivery payment for the goods or delivery company, and orderer terminal as terminal used by the orderer selects and inputs delivery address information for delivering a goods from the selected delivery company on the basis of the delivery zone information;

Online open delivery system includes; The delivery company server as server operated or managed by a delivery company sign up as a member on the delivery management server, and provide the information of delivery fee, delivery method and point according to the information of delivery company and delivery zone linked to a website or online shopping mall, and delivery server that delivers the product purchased by the orderer; and shopping mall operation server as server which operated or managed by the administrator of the online shopping mall provides online shopping mall information and product information linked to a website after sign up as a member after connects on the delivery management.

The delivery management server interlocks with the online shopping mall provides a payment interface to performs all purchase payment of goods and delivery payment of delivery selected by orderer, or only delivery payment, and performs the delivery payment to finally calculate the delivery charge compare the first delivery charge to the second delivery charge calculated by the delivery company server after the first delivery charge is automatically calculated based on the delivery information inputted by the orderer when paying delivery payment.

The delivery company server collects and delivers of the delivery goods in association with first collecting terminal for collecting delivery goods on the move, second collecting terminal for collecting delivery goods without moving, first delivery terminal for delivering delivery goods on the move and second delivery terminal for delivering delivery goods without moving, and calculate the first delivery charge automatically based on the weight and volume information of the goods and the delivery address information included the delivery information, and can provide to the delivery company server after the measured weight and volume information of the delivery goods is set as the second delivery charge by any one among the first collecting terminal, the second collecting terminal, the first delivery terminal, and the second delivery terminal

The delivery management server of online open delivery system may include the following units; member registration unit in which a plurality of online shopping malls and delivery companies are registered as members; website mediating unit which provide the online shopping mall to orderer terminal; information input unit in which is inputted information of goods selection, delivery methods' selection, purchase payment, delivery payment, and delivery address selection in the orderer terminal, and selected delivery company by seller or administrator in the online shopping mall; delivery address database which is stored delivery zone information entered by delivery company and the delivery rate information and delivery method information according to the delivery zone information; mediating unit of goods purchase which mediate information of goods selection and purchase payment input by orderer terminal between the online shopping mall and orderer terminal; mediating unit of goods delivery which mediate information of delivery method selection and delivery charge payment input by orderer terminal between the website and delivery company server; payment agency unit for providing a payment interface to perform both the purchase payment for the goods and the delivery payment for the delivery selected by the orderer terminal, or perform only payment for delivery; providing unit of delivery information for providing the order information, delivery information, delivery charge information, and delivery status information; and control unit for controlling the operation of each component constituting the delivery management server.

The delivery management server may include; providing unit of price information that lists information of delivery methods and delivery charge according to the delivery address information inputted by the orderer, or provides it to the web page after adds each the goods (price) and the delivery charge among the goods information registered by shopping mall operations server, and the delivery zone information registered by the delivery company server.

The delivery management server may share information of seller and buyer with shopping mall operations server in the online shopping mall, and not be shared with the delivery company server.

### Effects of the Invention

The online open delivery system according to an embodiment of the present invention can deliver the goods of the online shopping mall through the delivery company selected by the orderer without the involvement of online shopping mall.

An embodiment of the present invention can easily pay both purchase charge and delivery charge of goods in the management server.

Also an embodiment of the present invention can be purchase and delivery of goods as a reasonable price.

### BRIEF DESCRIPTION OF FIGURES

FIG. 1 is a diagram schematically showing online open delivery system according to an embodiment of the present invention.

2 is a block diagram schematically showing the management server of FIG. 1.

FIG. 3 is a flowchart illustrating operation of online open delivery system according to an embodiment of the present invention.

FIG. 4 is a view illustrating an example of a state in which choose a dedicated delivery company to deliver goods or inputs address information by orderer in an online open delivery system according to an embodiment of the present invention.

FIG. 5 is a diagram illustrating an example of a state in which delivery payment is made in online open delivery system according to an embodiment of the present invention.

FIGS. 6 and 7 are views showing an example of state before and after a delivery company creates a delivery zone in online open delivery system according to an embodiment of the present invention.

FIG. 8 is a flowchart illustrating an example of a delivery charge calculation process when first delivery zone information is selected in online open delivery system according to an embodiment of the present invention.

### BEST MODE FOR CARRYING OUT OF THE INVENTION

The terms used in this specification are briefly described, also this invention will be described in detail.

The terms used in the present invention have selected the general terms that are widely used now considering the function of the present invention, but this can be changed depending on the Intentions of skilled person engaged in this field, or precedents and emergence of new techniques. There are also terms chosen arbitrarily by the applicant in certain cases and the term is described in detail in the relevant part of the invention. Therefore, the terms used in the present invention should be defined based on the meaning of the terms and the contents throughout the present invention, not on the name of the simple terms.

When a certain part is “includes” a certain component throughout the specification, it means not to exclude other elements, but may include other elements unless opposite writes specifically. A term of “_unit”, “module” described in the specification means one or more function or a unit that processes an operation and it can be implemented as hardware or software, or as combination of hardware and software.

The present invention will be described in detail so that it can be easily carried out by a person having ordinary knowledge referring to the accompanying drawings for the embodiment of the present invention. The present invention may be embodied as many different forms, and the present invention is not limited to the embodiments described herein. Parts not related to the explanation are omitted to clarify the invention in the drawings. The similar part is marked with the similar sign of drawing throughout the specification.

Delivery zone information of the delivery management server in the present invention is domestic and overseas address information registered by the delivery company in linked with the delivery company server, and is the same as the delivery zone information in the previously registered patent No. 10-1702240 of the present applicant (Name of invention; ‘Delivery fee calculation system of goods’ in ecommerce), The delivery management server in the present invention applies the same automatic calculation method of delivery charge based on the delivery zone information.

Current delivery business can be classified as off-line and phone-line.

Offline delivery business is the post offices and their branches in each country. Currently, there are online shopping malls (On-Line Shop) and stores in each area (Off-Line Shop) at the form of selling the current product. Stores and post offices in each area can be offline delivery companies (Off-Line Shop).

Phoneline delivery company business is a business way of making the connection between the sender and the delivery company through telephone, and the company which does the postal (delivery company) business belongs here. Typical companies are FedEx, DHL, UPS, TNT, and so on. These companies have a homepage, but this homepage plays a similar role as the home page of general companies, and does not play the role of online delivery by internet. In addition, there is almost no service to input delivery information to the person who sends the goods in their homepage.

There is no company that does the right online delivery business at present, and the present invention presents the idea of such online delivery business.

Hereinafter, one or more delivery companies and online shops, one or more general people and general companies who want to send parcels sign up to website of delivery management server and send goods or parcels through online open delivery system.

Also, online open delivery system provides product price comparison page's service for the members who are subscribed to the delivery management server and the internet shopping mall's members, The company independently provides the point system to the customers, for customers who use a lot of delivery service, the delivery and provides a service that applies the differential delivery fare to customers who use one per month or 1000 per month.

Also, the delivery management server can operate the point system separately. The point system is a score given to customers who use a lot of delivery, and it means a discount of the delivery rate. The following things belong to the point; points, customer grades (each delivery company and delivery management server separately set), reserves and coupons, etc.

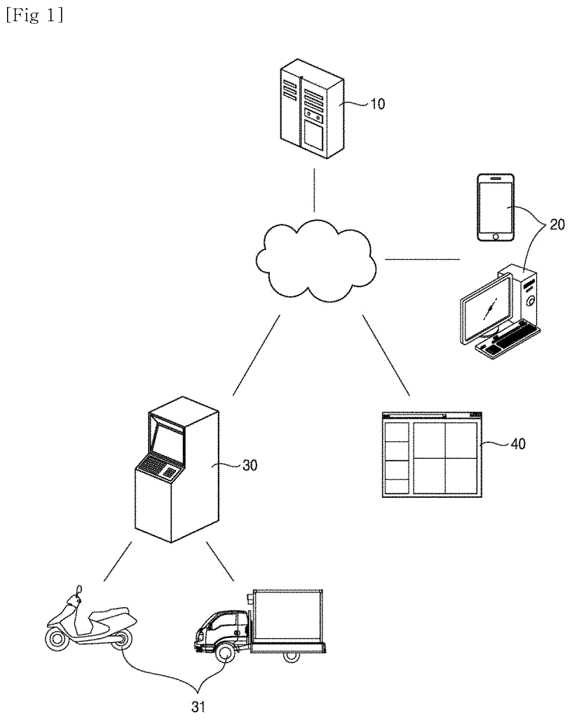

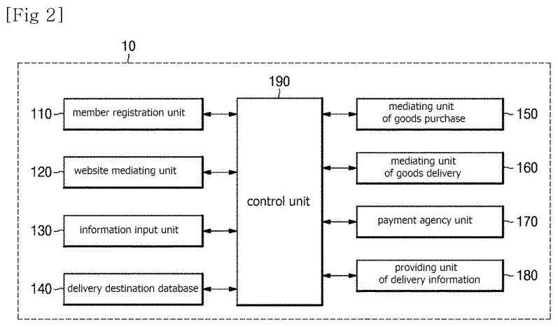

FIG. 1 is a view schematically showing an online open delivery system according to an embodiment of the present invention,

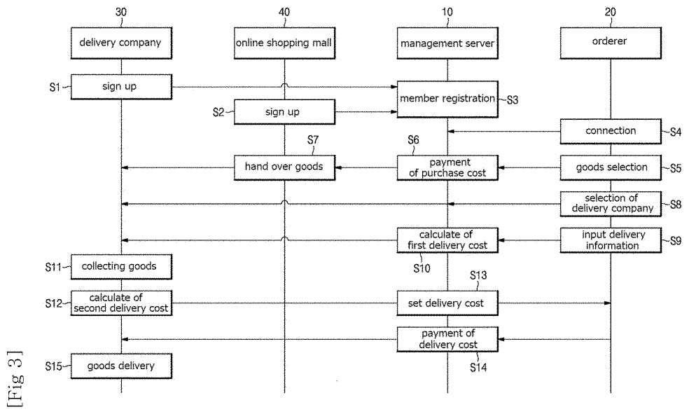

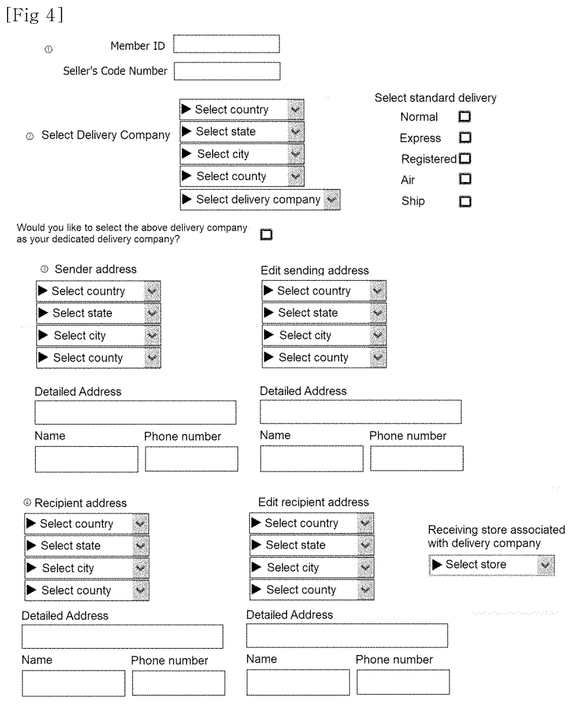

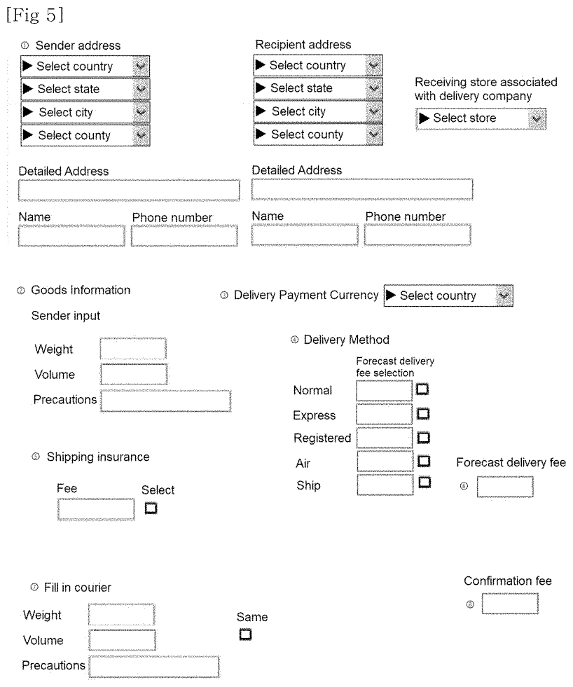

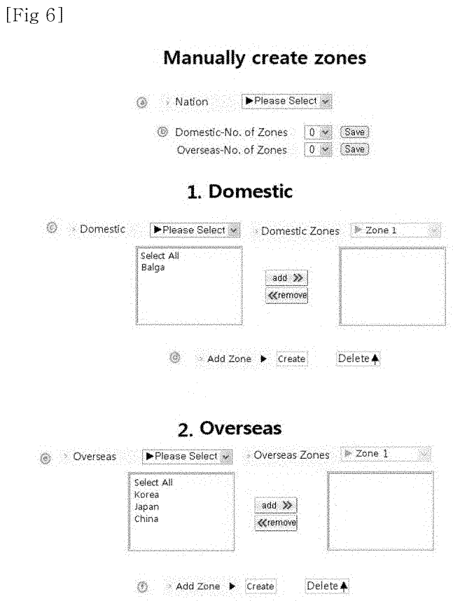

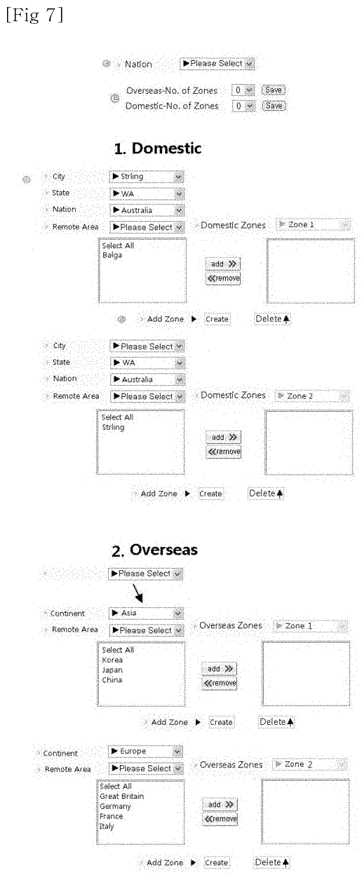

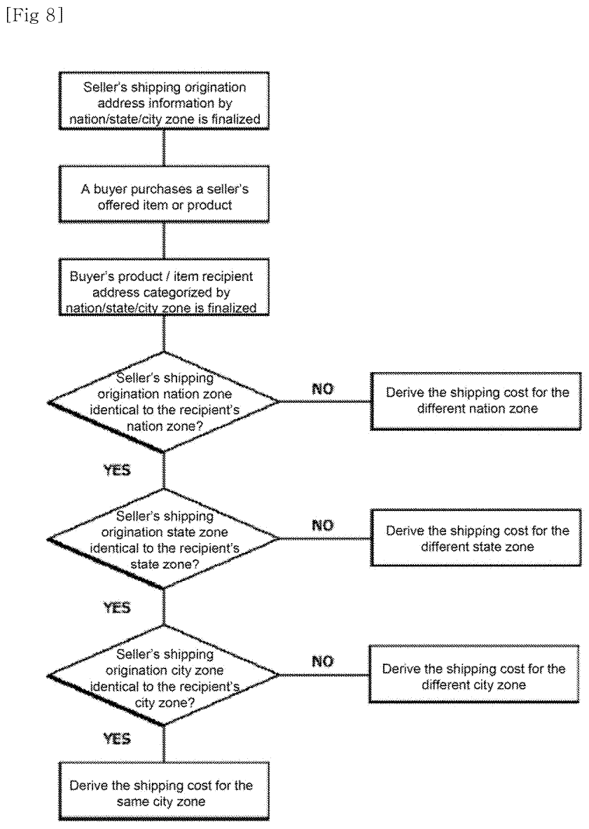

FIG. 2 is a block diagram schematically showing the management server of FIG. 1. FIG. 3 is a flowchart illustrating an operation of online open delivery system. FIG. 4 is a view illustrating an example of a state in which choose a dedicated delivery company to deliver goods by orderer or inputs address information in an online open delivery system according to an embodiment of the present invention. FIG. 5 is a diagram illustrating an example of a state in which delivery payment is made in online open delivery system according to an embodiment of the present invention. FIGS. 6 and 7 are views showing an example of state before and after a delivery company creates a delivery zone in online open delivery system according to an embodiment of the present invention. FIG. 8 is a flowchart illustrating an example of a delivery charge calculation process, when first delivery zone information is selected in online open delivery system according to an embodiment of the present invention.

As shown in FIG. 1, an online open delivery system according to an embodiment of the present invention is a system for delivering goods of an online shopping mall through delivery company selected by an orderer, and also include delivery management server (10), orderer terminal (20), delivery company server (30) and shopping mall management server (40).

The online open delivery system according to an embodiment of the present invention can receive order information from the orderer terminal (20), and deliver it to the delivery company server (30) and the shopping mall management server (40). The delivery management server (10) can deliver the delivery information received from the delivery company server (30) to the orderer terminal (20). Here, the orderer terminal (20) may include mobile methods such as computer, telephone, or mobile phone.

The delivery management server (10) provides information of a plurality of online shopping malls and delivery companies subscribed as members through a website, and provides address information of domestic or overseas (hereinafter delivery zone information), delivery charge information according to the delivery zone information, delivery methods information and point information registered by the delivery company on the website, and is delivered the goods purchased at a specific online shopping mall by orderer (company or individual) to the destination through the delivery company selected by the administrator or seller of the online shopping mall.

Also, the delivery management server (10) is connected to the online shopping mall, and provides a payment interface for performing both purchase payment of goods and delivery payment of delivery selected by orderer, or to perform payment of delivery only.

At this time, delivery management server (10) automatically calculates the first delivery charge based on the delivery information inputted by the orderer when paying for delivery, and can perform the delivery payment after finally calculates the delivery charge compares the first delivery charge with the second delivery charge calculated by the delivery company server (30).

The delivery management server (10) includes member registration unit (110), website mediating unit (120), information input unit (130), delivery address database (140), mediating unit of goods purchase (150), mediating unit of goods delivery (160), payment agency unit (170), providing unit of delivery information (180), and control unit (190) as shown in FIG. 2.

The delivery management server may include the following units; although not shown, the delivery management server (10) may include providing unit of price information which providing to the web page by listing delivery method information and delivery charge information according to the delivery address information inputted by the orderer or adding up the goods price and the delivery charge among the goods information registered by the shopping mall management server (40) and the delivery zone information registered by the delivery company server (30)

Although not shown, the delivery management server (10) includes; generator unit of address zone, information input unit of delivery zone, determination unit of delivery zone, selection unit of delivery commodity, choice unit of delivery method, currency generation unit, determination unit of recipient address information, calculation unit of delivery charge, code providing unit, copying unit of delivery zone, storage unit, payment performing unit, and microcomputer.

The generator unit of address zone generates the domestic or oversea address zone consisting of city, state zone, and nation marked in each national language through a website, and these addresses can be associated with the postal code of each country.

Delivery zone information for delivering goods from at least one or more delivery company server (30) based on the address zone generated by the generator unit of address zone is inputted in the input unit of delivery zone information.

Desired delivery zone information by buyer terminal is confirmed in the determination unit of delivery zone.

Information of commodity and their sender address are confirmed by the seller terminal, and price information about the commodity is inputted in select unit of delivery goods.

The selection unit of delivery commodity provides the first delivery zone information to the storage unit when the first delivery zone information inputted by the seller terminal is selected. At this time, the information of first delivery zone is set to be able to be inserted, modified and deleted by the seller terminal.

When information of second delivery zone inputted by delivery company server (30) is selected, selection unit of delivery commodity selects unit of delivery goods provides the information of second delivery zone to the storage unit. At this time, the seller terminal can select the information of second delivery zone as inputting the code information including at least one of the code number, the barcode or the QR code provided from the delivery company server (30).

The choice unit of delivery method selects or inputs delivery options, delivery method and delivery fee of goods by the seller terminal.

The currency generation unit generates a currency for the goods price by the seller terminal. The currency generation unit has a currency exchange program for exchanging money with domestic or foreign currency units in advance. The currency generation unit provides key currency information, the information of seller's and buyer's currency that the seller and buyer are willing to receive and pay, exchange rate information provided by the delivery company or financial institution and fee information charged when exchange by exchange rate information by executing the exchange program.

The determination unit of recipient address information selects and inputs the receipt address information receiving specific goods by buyer terminal that want to buy specific goods in website.

The calculation unit of delivery charge calculates delivery charge of the specific commodity corresponding to the sender address information and recipient address information of commodity based on delivery charge information. If the information of first delivery zone inputted by the seller terminal is selected, the calculation unit of delivery charge calculates the delivery fee inputted for each nation, each state zone and each city after determining whether the nations, state zones and cities of sending address and the nations, state zones and cities of receiving address are sequentially the same or not.

The code providing unit provides the each code of goods or company to the seller terminal or the delivery company server (30).

The copy unit of delivery zone can be copied and shared the delivery zone information generated by the seller terminal or the delivery company server (30). Also the copying unit of delivery zone can share the delivery zone information by request from other seller terminal and permission of management terminal of ecommerce site.

The storage unit stores the address zone and the delivery zone information, the commodity information, the sender address information, the price information of goods, the delivery options, the delivery method, the delivery charge, the currency and the receipt address information. The storage unit may store order information received from the orderer terminal (20), goods information received from the management server of shopping mall (40), delivery information received from the delivery company server (30) and code provided from code providing unit. The storage unit stores a program for processing and controlling of microcomputer. The storage unit may perform a function for temporary storage of input/output data. The storage unit may include the web storage for performing a storage function on the internet. The ‘storage unit’ (383) may include a storage medium of at least one type of Flash memory type, hard disk type, multimedia card micro type, Card type memory (e.g., SD or XD memory, etc.), RAM (Random Access Memory), SRAM (Static Random Access Memory), ROM (Read-Only Memory), EEPROM (Electrically Erasable Programmable Read-Only Memory), PROM (Programmable Read-Only Memory), Magnetic memory, Magnetic disk, or Optical disk.

The payment is performed by the buyer terminal purchasing the goods using the information of key currency, seller's currency, buyer's currency, exchange rate and fee in the payment performing unit linked with an external payment server,

The microcomputer controls the operation of generator unit of address zone, information input unit of delivery zone, determination unit of delivery zone, selection unit of delivery commodity, choice unit of delivery method, currency generation unit, determination unit of recipient address information, calculation unit of delivery charge, code providing unit, copying unit of delivery zone, storage unit and payment performing unit by already set the program to calculate and use the optimal delivery charge and goods prices, after seller or delivery company generates an optimal delivery zone, using the address zone provided on the website.

When member information is inputted by a plurality of online shopping mall managers and a delivery company who access a website provided by the delivery management server (10), the member registration unit in which a plurality of online shopping malls and delivery companies are registered as members authenticates and registers members.

The website mediating unit (120) provides a plurality of online shopping malls registered as members to the orderer terminal (20).

Information about goods selection, selection of delivery method, purchase payment, delivery payment, and selection of delivery address inputted from the orderer terminal (20) input in the information input unit (130). Delivery Company by the seller or manager of online shopping mall is selected in the information input unit (130).

The delivery zone information inputted by the delivery company, and delivery charge information and delivery methods information according to their delivery zone information are stored in the delivery address database (140). Also, the delivery zone information input from the operating entity of the delivery management server (10), and the delivery charge information and the delivery methods information according to their delivery zone information can store in the delivery address database (140). The delivery address database may be formed integrally with the above-mentioned storage unit.

The mediating unit of goods purchase (150) mediates the goods selection information and the purchase payment information input from the orderer terminal (20) between the online shopping mall and the orderer terminal (20).

The mediating unit of goods delivery (160) mediates the selection information of delivery methods and delivery payment information input from the orderer terminal (20) between the website and the delivery company server. The mediating unit of goods delivery (160) may also perform a function of scheduling to be available the delivery when the orderer wants it based on the selection information of delivery methods.

The payment agency unit (170) provides interface to performs both purchase payment about goods and delivery payment about delivery selected by the orderer terminal (20), or to perform delivery payment about delivery only.

The providing unit of delivery information (180) provides information of order, delivery, delivery charge, and delivery status through a display interface.

The control unit (190) for controlling the operation of each component constituting the delivery management server (10) controls provides information of plurality's online shopping malls and Delivery Company registered as a member by a preset program through a web site, and provide the delivery zone information registered by delivery company on the website, and controls to deliver the goods purchased by the orderer to the destination address through selected delivery company. The control unit (190) may be formed integrally with the microcomputer.

Meanwhile, the delivery management server (10) can be designed to share the information of seller and buyer in the online shopping mall with the shopping mall operations server (40), and cannot be designed to share with the delivery company server (30).

The components of two or more among member registration unit (110), website mediating unit (120), information input unit (130), delivery address database (140), mediating unit of goods purchase (150), mediating unit of goods delivery (160), payment agency unit (170), providing unit of delivery information (180), and control unit (190) may be performed by one processor. It should be noted that each component is divided by function for convenience of explanation.

The orderer terminal (20) used by the orderer performs goods selection from any one among a plurality of online shopping malls provided by the delivery management server (10), and delivery methods selection provided by the delivery management server (10), and purchase payment or delivery payment for the goods or the delivery company, and selects and inputs the delivery address information to receive the goods from the delivery company selected based on the delivery zone information.

Orderer terminal (20) of as the buyer's terminal device who wants to purchase the goods of a seller on an online shopping mall after accessing the website and register as buyer member selects and registers the goods and the good's information which want to purchase on the website, and selects a delivery company on the website and registers the product recipient address, and performs payment of the delivery charge.

Information of sender address, telephone number, sender name, recipient address, telephone number, recipient name, delivery company selection, delivery method selection (normal, express, registered, air. ship etc.), selection of parcel numbers, etc., can be inputted in the orderer terminal (20).

Orderer terminal (20) in the present invention may include the buyer who selects a goods and requests delivery, the person who wants to general delivery of parcels and the seller who requests delivery of goods.

The delivery company server (30) is a server operated or managed by the delivery company, and sign up as a member after connect to the delivery management server (10), and provides delivery company information, delivery zone information, delivery charge information based on the address information and delivery method information linked to a website, and delivers the goods purchased by the orderer to the entered delivery address.

The delivery company server (30) collects and delivers goods in connection with first collection terminal for collecting the delivery goods with moving, second collection terminal for collecting the delivery goods without moving, first delivery terminal for delivering the delivery goods with moving, and second delivery terminal for delivering the delivery goods without moving.

The first collection terminal, the second collection terminal, the first delivery terminal, and the second delivery terminal may include immobility type that does not move such as convenience stores, clothing stores, shops, etc., and mobility terminals, places, or devices such as vans, trucks and motorbikes, etc. The first collection terminal, the second collection terminal, the first delivery terminal, and the second delivery terminal for the delivery company is shown at 31 of FIG. 1.

The first collection terminal, second collection terminal, first delivery terminal, and second delivery terminal can be provided to the delivery management server (10) through the delivery company server (30) after specifying the weight or volume of the delivery goods using a weight or volume measuring means such as a scale or volumetric instruments.

The delivery company server (30) automatically calculates first delivery charge based on delivery address information using the weight and volume information of goods included in the delivery information, and can be provided to the delivery server (30) after the measured weight and volume information of the delivery goods is set as the second delivery charge by any one among the first collection terminal, the second collection terminal, the first delivery terminal, and the second delivery terminal.

For example, the first collection terminal, the second collection terminal, the first delivery terminal, and the second delivery terminal may be equipped with computer or mobile phone (homepage check), van (truck), scale (fixed scale, handrail), sticker generator (print the data entered by the sender of the parcel such as address—print it and attach it to the parcel), pos terminal (card payment except cash), authentication terminal that has received parcels (parcel who receive the parcels signs it),

The first collection terminal, the second collection terminal, the first delivery terminal, and the second delivery terminal may perform the functions of one or more among immobility collection, mobility collection, immobility storage and pass over and mobility delivery. Immobility collection and immobility storage and pass over are available at convenience stores. Mobility collect and delivery may be available to companies or individuals who have a van or truck.

The delivery company server (30) may pick up the parcel at home (office, factory), or deliver the parcel to the convenience store or house. Recipient can go to the convenience store (near the home) and pick up the parcel.

If a nonmember among orderer calls a parcel collector (mobility or immobility) without entering information on the website, the parcel collector will enter the information instead the nonmember and receive a separate fee.

If people call a van in the situation where the sending address, receiving address and the delivery method is decided after select the item for mobility collection, delivery company server (30) is linked the each collection terminal and delivery terminal so that the reservation time of the van or truck (ex; Jul. 23, 2017 1:30 pm-2:30 pm) is automatically displayed. When the item is selected for the immobility collection, delivery company server (30) after inputted information can take the parcels to the immobility collection terminal or the delivery terminal where it is nearest or convenient locate and send the parcel.

Accordingly, the parcels collected by first collection terminal and second collection terminal are transported directly to the warehouse or if the recipient calls directly, parcels may be collected directly to the warehouse and delivered.

The shopping mall management server (40) is a server operated or managed by an administrator of the online shopping mall, and join as a member after connect to the delivery management server (10) and provides online shopping mall information and goods information linked to the website.

The shopping mall management server (40) may also be associated with seller terminal that sells the commodity.

The seller terminal, the buyer terminal, the first collection terminal, the second collection terminal, the first delivery terminal, and the second delivery terminal in the present invention may include the following personal information terminals in order to receive service of this online open delivery: smart phone capable executing of Internet browsers and applications on the equipment, IPad, PDA (Personal Digital Assistant), HPC (Hand Personal Computer), web pad, notebook, WAP (Wireless Application Protocol) phone, Palm PC, e-Book terminal, HHT (Hand Held Terminal), PC, Smart TV ect.

As shown in FIG. 3, the online open delivery system according to an embodiment of the present invention includes can be implemented as the following process; the delivery company server (30), the shopping mall operations server (40), the delivery management server (10), and the orderer terminal (20).

Hereinafter, for convenience of explanation, delivery company server (30) can describe as delivery company, shopping mall management server (40) can describe as online shopping mall, and the orderer terminal (20) can describe as orderer.

First, the delivery company and the online shopping mall performs membership registration procedure (S1, S2) after register each company information on a website provided by the delivery management server (10).

It is registered as a member based on each company's information (S3) in the delivery management server (10).

At this time, the delivery company can also register the delivery zone information on the website.

The orderer after accesses the website (S4) pays the price of goods purchase (S6) after selecting to order or purchase goods at a desired online shopping mall among a plurality of online shopping malls (S5).

The goods selected and paid by the orderer hand over to the delivery company server from online shopping mall (S7).

The orderer selects the delivery method that meets his requirements on the website (S8) and enters the delivery information (S9).

The delivery management server (10) automatically calculates the first delivery charge (S10) based on the delivery information input by the orderer and the delivery zone information input by the delivery company.

The delivery company collects the goods (S11), and measures the weight and the volume of the goods, and calculates the second delivery charge (S12) based on the measured information and the delivery zone information input by the delivery company.

The delivery management server (10) determines the final delivery charge (S13) by algorithm of pre-set charge determination based on the first delivery charge and the second delivery charge.

When the orderer pays the determined final delivery charge (S14), the delivery company delivers the goods to the destination (S15).

The online open delivery system configured as described above according to an embodiment of the present invention can deliver goods of an online shopping mall through a delivery company selected by an orderer without involving the online shopping mall. In addition, the embodiment of the present invention can easily settle both the goods purchase charge and the delivery charge in the management server. In addition, an embodiment of the present invention can purchase and deliver the commodity as reasonable price.

Hereinafter, with reference to FIG. 4 or FIG. 8, a description of a specific process performed in the online open delivery system according to an embodiment of the present invention will be described in more detail.

The delivery company joins as a member after access the website provided by the online open delivery system, and inputs own delivery zone and the corresponding delivery charges, and inputs delivery methods such as normal, express, registration, air, and ship and other information, and sets a point system for the customer (see FIGS. 6 to 7).

For example, when general person tries to send a package to a relative or other person, people usually go to the post office, in this case, log in to the website provided by the delivery management server and send the parcel. At this time, the general person inputs the personal information such as address requested by the delivery management server after signing up. When a nonmember sends a parcel, the delivery management server provides a temporary delivery code and enters delivery information related to the delivery code.

Also, general companies that use a lot of delivery service usually send their documents or parcels abroad using common delivery companies. In this case, general company logs in to the website provided by the delivery management server and send the parcels or documents. General companies enter the personal information such as address requested by the delivery management server after signing up as member. Then select a dedicated delivery company that are trading or want to trade. These companies can meet with the delivery company off-line before or after choosing dedicated delivery company, and consult the delivery rates in advance. The delivery company can apply the consulted delivery rate using the point system.

The online shopping mall subscribes to the website provided by the delivery management server and inputs the required information. This is to transfer the parts related to the delivery to the specialist (the delivery company subscribed to the delivery management server).

In the case of sellers who use a lot of delivery services, the goods seller subscribes in the delivery management server of the website as an individual or seller of online shopping mall and enters the seller's unique code given by the online shopping mall into the information column of the delivery management server and chooses a dedicated delivery company among the delivery companies subscribed to the delivery management server and then chooses a standard delivery (see 0 in FIG. 4). Entering the unique code of the seller and selecting a dedicated delivery company by seller means that the dedicated delivery company and the seller's online shopping mall share information on the system.

If the seller receives the delivery service from the delivery management server, the online shopping mall to which the seller belongs must be a member of the delivery management server.

In the case of buyer receiving goods, the buyer can select the delivery method (normal, registered, express, air, ship, shipping insurance, etc.) of the dedicated delivery company selected by the seller. (see \textcircled{2}, \textcircled{3}, \textcircled{4}, \textcircled{5} in FIG. 5). In this case, the buyer of the goods does not select the delivery methods on the website of the delivery management server, but the buyer selects on the website of the online shopping mall where the goods are purchased. That is why the system of delivery management server and online shopping mall should be compatible.

Here \textcircled{2} is the case where individuals send goods to others casually. General companies of \textcircled{3} send their goods or documents using the delivery company almost every day. Because of these general companies, each delivery company uses point systems and manages their customers. The delivery management server receives the payment of the delivery charge from the individuals and the general companies, and delivers it to the delivery company. Of course, the payment amount will be received the amount determined by the point system provided by the delivery companies (discounted delivery rate).

The case of \textcircled{4} should be shared a part of information of the system of delivery management server and online shopping mall.

In the case of the payment system, the delivery management server may transfer the rights of part (delivery charge) or all (goods sales payment and delivery charge) of the online shopping mall's payment systems. Also, according to the request of the online shopping mall, the online shopping mall can receive all the payment without transferring the payment to the delivery management server.

For example, if a part of payment is transferred, the online shopping mall transfers only the collection right of the delivery charge to the delivery management server among the good's price and delivery charges sold at the online shopping mall. In this case, the delivery management server receives the payment of delivery charge from the buyer of the online shopping mall, and gives the delivery charge to the delivery company.

Also, when transferring a part of payment, there are domestic and overseas payment among payment of the goods price and the delivery charge which are sold in the online shopping mall. In the case of domestic, payment is received in each online shopping mall, and in the case of overseas, payment is received in the delivery management server. For example, online shopping mall in Korea receives the payment from Korean PG Company (INICIS, etc.). In case of overseas, payment is received in a delivery management server using an overseas payment company (PayPal, AliPay, etc.).

When transferring all of payment, both the goods price and the delivery charge are received in the delivery management server, and the delivery charge except certain fees pay to the delivery company, and the goods price payment pays to the online shopping mall. If the online shopping mall transfers all of the payment to the delivery management server, the online shopping mall doesn't need subscribes to the PG Company, and is no need to obtain permission from each card company related to the PG Company.

In the payment described above, the buyer's payment is made at the online shopping mall where the goods are purchased. The actual payment is made to the delivery management server by system compatibility between the delivery management server and the online shopping mall. Here, the delivery management server receives the goods price and hand over the payment just like PG Company, and it is the responsibility of the online shopping mall to return the defective product which occurs afterwards.

The product price comparison page should share product information (product price, goods sender address, etc.) of the sellers subscribed to each online shopping mall and information of the dedicated delivery company selected by the seller.

Thus, the product price comparison page can provide the goods price presented on website of each online shopping mall and delivery charge of the delivery management server to buyer.

When the seller enters the seller code number and selects dedicated delivery company after the seller joins to the delivery management server, the delivery method and the delivery charge of the delivery company selected by the seller are displayed in the goods delivery column of the online shopping mall to which the seller belongs.

Delivery companies cannot share information and addresses of sellers and buyers of online shopping malls because personal information infringement.

When the order for the goods delivery comes, only the information related to the goods delivery of the seller and the buyer are received.

Online shopping mall sells their products on own website, and the delivery management server can help product sales of the online shopping mall with providing the delivery system, the product price comparison system, and the payment system.

There are a lot of sites that can compare the prices of the current products. The prices offered by these sites are only goods prices and do not include delivery charge. However, the product price comparison provided by the delivery management server on the website shows ‘product price+delivery charge=total amount’. If 100 people search for a specific goods sold by one seller on the product price comparison page, the price of the goods will be the same, but 100 delivery charge may appear differently. When the member logs in, the address of seller and buyer are already entered, so system can find the delivery charge automatically. When a non-member searches for a product, server finds the delivery charge by seller's address and IP address of the person viewing the goods. More specifically, when people watch the product on the product price comparison page, the seller's goods price and the standard delivery price of the dedicated delivery company (\textcircled{2} in FIG. 4) selected by the seller are shown. If the seller does not specify a standard delivery, the lowest delivery rate offered by the delivery company is shown.

If a preliminary buyer of goods has searched for a price on the product price comparison page and the goods price that delivery charge is not marked separately or the free delivery is displayed, the delivery charge is included in the goods price.

On the other hand, the point providing system provided by the delivery management server will be described below. First, the point system of present online shopping malls is a system to discount the goods price using coupons, reserves, and adjustment of customer grades.

Generally, sellers cannot offer coupons directly, or adjust their points and customer grades to buyer at online shopping malls. The buyer buys the goods almost once at the online shopping mall. Buyer purchases the same item 2 or 3 times in the unusual case. If a buyer purchases 100 or 1,000 specific items from a particular seller for a month, buyer may be purchasing for business purposes. However, general companies and sellers can use 100 or 10,000 delivery services per month for a specific delivery company. For this reason, the delivery management server provides a system to run points on each delivery company's My Page.

The delivery management server can also provide coupons to the members for discount delivery charges, and can give a reserves for members who use a lot of delivery services.

Delivery companies subscribed to a delivery management server can also operate their own point system (a system that cannot be seen in online shopping mall). Delivery companies may operate the following point systems separately from the delivery management server; up or down of customer grades (customer grades—if customer uses a lot of specific delivery company, the grade will increase), coupons and reserves etc.

The delivery management server establishes a system including the address system mentioned in the previous patent, and provides a system built in one or more Delivery Company and online shopping malls and general people and general companies who want to send the goods registered as a member.

The delivery company will create own delivery zone and fill in the delivery charges associated with the delivery zone using the address system provided by the delivery management server It also provides delivery charges related to the delivery methods (normal, registered, express, etc.). (See \textcircled{2} in FIG. 4 and \textcircled{4} in FIG. 5)

The general people, the general companies and the sellers using the service provided by this delivery company send commodity.

Here, let's take a look at how the people and general company use the courier service.

First, people and general companies join in the delivery management server.

Then, enter information including the address during member registration. If people chooses a dedicated delivery company later on, this address becomes the sender address in \textcircled{3} of FIG. 4. Also, ID received when join as member is automatically displayed in \textcircled{1} of FIG. 4.

If people doesn't have a delivery company that people is dealing with, find and select the most appropriate delivery company among the delivery companies subscribed to the delivery management server (\textcircled{2} in FIG. 4). Here, if the delivery company is a store, select a store. In addition, the general company may also register with the delivery company (in this case, a role similar to the store) and they may also process items they want to send. General companies that use a lot of delivery services can reduce delivery expenses as created a delivery department.

Then enters the sender address to sending goods. It is also determined whether the person to receive the goods receives at the home address or in the shop (convenience store, restaurant, etc.) cooperated with the delivery company (FIG. 4 \textcircled{4}). In this case, the person who sends the goods determines it.

Then, input the data required by the delivery company, such as the volume and weight of the goods (fill in the weight temporarily if sender has a scale), etc. (\textcircled{2}, \textcircled{3}, \textcircled{4}, \textcircled{5} in FIG. 5)

If sender selects the country in currency item of delivery payment in \textcircled{3} of FIG. 5, it means to pay the delivery charge as the currency of the selected country. Delivery companies decide usually which country's currency to accept. If the delivery company only accepts one currency, there is no currencies choice of the person sending the goods.

When all of this information is inputted and the estimated weight of the object is included, the estimated delivery charge is displayed on the screen (\textcircled{6} in FIG. 5).

In case of delivery company is a car owner (vehicle), when orderer enters such data, the system sends automatically forecast date and time to collect the parcel and the phone number of delivery collector to the sender.

The delivery company comes to the forecast time, and weighs the goods with the scales of the delivery company. If it is equal to the estimated weight, it receives the estimated delivery charge. If the weight (the delivery information inputted by the person who send the goods) is wrong, edit the entered information, and receive the corrected delivery charge, and take the item (\textcircled{7} and \textcircled{8} in FIG. 5).

If the delivery company is a store, sender take the goods to the store selected from the dedicated delivery company after inputting the data necessary for delivery (FIG. 4, FIG. 5), and provide the ID (ID of the delivery management server) to the person in charge of the delivery in store.

If the store staff can check the ID of the person who wants to send the commodity in the store's computer, staff can see the delivery information entered by the person who wants to send the commodity.

If it is equal to the estimated weight (delivery information) after weighing the goods using store's scale, staff receives the estimated delivery charge. If the weight is incorrect, receive the modified delivery charge after modify the weight (delivery information) entered as the forecast weight, and receive the goods. (\textcircled{7}, \textcircled{8} in FIG. 5)

Because the sender directly inputs the sending address and recipient address (delivery information), it can be safer, convenient and time-saving in the position of the delivery company which delivers the goods.

Also, when the seller and buyer of the online shopping mall use the delivery company, the seller and online shopping mall subscribes to the delivery management server and makes compatible with some systems and information.

The seller enters the goods information and the sender address in the online shopping mall (this is linked to the delivery management server—\textcircled{3} in FIG. 5). Here, the seller receives the seller code number provided by the online shopping mall.

Seller can join personally as a member in website of the delivery management server, or register as a member using the ID of the online shopping mall selling the goods. In the column for inputting the seller code number, the seller enters seller's own code number assigned in the online shopping mall (\textcircled{1} in FIG. 4).

If seller doesn't have delivery company that seller is dealing with, seller choose the most suitable delivery company (dedicated delivery company). In this case, seller can meet with the delivery company directly and talk about delivery.

Seller finds the name of the delivery company in the list of delivery companies, and select delivery company as a dedicated delivery company, and selects one among the delivery methods offered by the dedicated delivery company as the standard delivery. (\textcircled{2} in FIG. 4)

In such a case, the goods sending address of the seller is automatically indicated at the column of sending address in \textcircled{3} of FIG. 4.

When the preliminary buyer browses specific goods at the online shopping mall or product price comparison page of delivery management server, delivery charge and goods prices are shown automatically to the buyer combined with delivery information entered by a dedicated delivery company selected by the seller selling the particular goods and buyer address information entered by the buyer. The delivery charge shown at this time is the delivery charge of the standard delivery selected by the seller in \textcircled{2} of FIG. 4.

When the buyer decides purchase of the specific goods of the specific seller, the buyer selects the payment currency, and the delivery methods (normal, express, registered, air, ship, etc.) presented by the delivery company and the corresponding delivery rate (\textcircled{2}, \textcircled{3}, \textcircled{4}, \textcircled{5}, \textcircled{6} of FIG. 7). The seller can also specify the payment currency for his goods price. If the designated currency of the delivery company and the seller are different, the card company makes the payment for each company's currency. In this case, the currency of the country where the buyer lives by automatic exchange rate calculation is shown in the product price comparison page. In this case, the seller and the delivery company may agree to settle only the domestic currency and the key currency in order to alleviate the confusion of the buyers by mutual agreement. In this case, the goods price shows the same country's currency for buyer who living in same countries as delivery companies and sellers in the product price comparison site and product details page of online shop. When the buyer is a third country, it is displayed in the key currency [\textcircled{3} of FIG. 5]. If the delivery company specifies only one country's currency, the buyer must make the payment in the designated currency without any choice.

If the buyer wants to receive goods at home, buyer select a home address. If buyer wants to receive the goods at a specific store near the house served by the dedicated delivery company of seller, the goods receipt location selects the store (\textcircled{1} in FIG. 5). In this case, the delivery price may be different when receiving the goods at home or at the store near the house, and this is optional for the buyer receiving the goods.

When a delivery company subscribes to a delivery management server, delivery company generates an address zone in the address system provided by the delivery management server, and apply delivery charges to the generated each address zones, and also create the delivery methods (FIGS. 6 and 7).

The delivery company collectively refers to the business owners who want to do the delivery business.

The type of delivery company includes followings; stores (all stores such as convenience stores, restaurants, etc.), owners of trucks, etc. (Those who use the vehicle to do the delivery business) and on-line delivery middleman.

When stores or cars owner join a delivery management server and try to start delivery business first time, they are difficult to make followings; create delivery zones and normal, express, registered (delivery methods according to zones), and delivery charges according to delivery methods. Also online delivery middleman connects the necessary vehicles during delivery, and finds the warehouse where the goods stay, and connects with other delivery companies which deliver the goods to the destination, and receive a certain amount among delivery charges by the shop or the car owners. An online delivery middleman plays the role of a freight forwarder.

When delivery companies collect goods using vehicle, the following are required: vehicles, scales, payment terminal to receive payment of delivery charge, computers or smart phones that can see the system and an output device that automatically prints sending address and the recipient address of goods when the payment is made, in case of receive the goods at the store, the following are required: stores, scales, payment terminal to receive payment of delivery charge, computers or smart phones that can see the system, and an output device that automatically prints sending address and the recipient address of goods when the payment is made.

In the meantime, let's look at the difference between delivery business using existing shops (convenience stores, restaurants, etc.) and vehicles.

Regarding the delivery using vehicle, existing normal delivery companies and international delivery companies (Fedex, DHL, UPS, etc.) using telephone for delivery business and the delivery business using the internet proposed in this patent have many differences. Existing delivery companies take the customer's phone and go to the place where the commodity is. The courier cannot give information about the delivery charge to the person who sends the goods, because courier goes to receive the goods under the circumstances like due the lack of information about where the item is delivered, weight and volume of the item etc. Also, even if sender gives delivery information over the phone to Delivery Company, both sides should spend a considerable amount of time, such as confusing spelling (lettering). In addition, when giving and receiving the commodity, the courier and sender spend considerable time meeting each other because all information is received in dialogue, and the delivery charge of the goods is extracted. For this reason, the delivery company may charge the delivery fee by dividing only two zones such as domestic and overseas for saving time. Examples of domestic of the US, the delivery company charges the same delivery rates from Hawaii to New York and from a city to the same city in Hawaii.

Regarding to the delivery business using store, let's look at the present store delivery business. Delivery companies will contact the stores, and provides delivery charge list according to their delivery zones and scales. When the delivery order arrives at the store, store staff checks manually the delivery address (delivery zone), the information about commodity and weight. Then store staff will receive the parcel after receiving the delivery charge shown in the delivery charge list. This delivery charge list is generally only available domestic and overseas service is not available. Also, after receiving the delivery items, the store man must call to the delivery company to receive the delivery items.

However, the present invention provides the delivery business for stores as following; store is not belonging to the delivery company but doing independent delivery business as store does delivery business after join to the delivery management server. Store can provide delivery service to the customers in cooperation with other delivery companies of domestic and oversea country.

Because delivery companies using vehicle or shop are going to pick up the goods after already received all the information except the commodity weight, they can save the time between the courier and the sender. It is possible to minimize omission, confusion and time-consuming of delivery information because all the delivery companies and all the person who sends the goods over the world are controlled by one system.

As a result in the present invention, one or more delivery companies subscribing to the website provided by the delivery management server may handle the parcels that persons and general companies want to send, and seller's goods sold on the online at the same time.

Delivery Companies who are subscribed to online delivery has the advantage of securing the general people's parcels (post office users in each country), general companies' parcels or letters and seller's goods of online shopping malls according to their efforts.

FIG. 7 will be briefly described. When the seller provides the completed delivery zone and the buyer confirms the receipt address of the goods, the calculation unit of delivery charge calculates the delivery fee inputted for each nation, each state zone and each city after determining whether the nations, state zones and cities of sending address and the nations, state zones and cities of receiving address are sequentially the same or not. It is determined whether or not the cities of the address information corresponding to each cities are sequentially the same or not, and the delivery rates for each city are calculated.

If registered buyers on the website confirm the goods recipient address when purchasing the goods, and then it is linked the delivery charge according to the delivery zone that the seller has confirmed. Here, the goods buyer can fill zip code and the detailed address only, and the other address (name of the national administrative system) must use the address input by the site administrator.

When the goods receipt address is completed, the delivery charge according to the respective delivery areas provided by the sellers is selected. People can see place names with the same spelling in each country or globally. In the case of Korea, there are the same place names in Jung-gu, Seo-gu, Dong-gu, Nam-gu and Buk-gu in each city. In this case, people can recognize that it is Dong-Gu of the XX city, but computers that are not programmed cannot be recognized. As a method of recognizing this, it is necessary to use FIG. 7 or the delivery code according to each address (name of administrative area).

if the buyer selects an address after compatible with the address system created by the website administrator and the address system of the postal code specified in each country as the same system like in FIG. 7 or the delivery code, the postal code can also be automatically generated and displayed. Even if there is a change of postal code or address later, the address or the postal code may be updated automatically. As another example, if the code of delivery company is ‘0082 02 05 01’ or the letter address ‘Samsung-dong, Gangnam-gu, Seoul, Korea’ is determined, the postal code ‘XXX-XX’ of ‘Samsung-dong, Gangnam-gu, Seoul, Korea’ may be automatically displayed. In this case, the letter address, area code of the Delivery Company, and postal code are same meaning.

In this case, if the address writer memorizes the postal code and enter the postal code directly in the postal code field “after selecting the country and language, the address (Administrative district) up to the postal code is shown automatically. In this case, just enter the postal code and detailed address.

The device described above may be implemented as hardware component, software component and/or combination of hardware component and a software component. For example, the device and component described in the embodiments may be implemented using one or more general purpose or special purpose computers as follows; processor, controller, ALU (arithmetic logic unit), digital signal processor, microcomputer, FPGA (field programmable gate array), PLU (programmable logic unit), microprocessor or any other device capable of executing and responding to instructions. The processing device may execute an operating system (OS) and one or more software applications performed on the operating system. The processing device may also access, store, manipulate, process, and generate of data in response to execution of the software. For ease of understanding, although the processing device can be described as one used, but person who has ordinary knowledge in the technical field can see that the processing device contains a plurality of number of processing elements and/or a plurality of types of processing elements. For example, the processing device may comprise a plurality of processors or one processor and one controller. Other processing configurations are also possible, such as a parallel processor.

The software may include a combination of one or more of a computer program, code, instructions, and may configure the processing device to operate as desired, or can command the processing device independently or collectively.

The software and/or data may be interpreted by the processing device or may be permanently or temporarily embodied in any type of machine, component, physical device, virtual equipment, computer storage media or device, or a signal wave to be transmitted for provide instructions or data to the processing device. The software may be distributed over computer system connected to network, and stored or executed as a distributed manner. The software and data may be stored on one or more computer readable recording media.

The method according to an embodiment can be recorded on a computer-readable medium after implemented in the form of a program command that can be executed through various computer means. The computer-readable medium may include as alone or combination following elements; program command, data files, data structures. The program command to be recorded on the medium may be those specially designed and configured for the embodiments or may be one that is known and available to a computer software vendor. The computer-readable recording medium includes the following hardware devices specifically configured to store and execute program instructions; hard disk, floppy disk and magnetic media like magnetic tape, CD-ROM, magnetic-optical like DVD (optical media), media like floppy disks, magneto-optical media like floptical disk, and ROM, RAM, flash memories, etc. Examples of program command include machine language code such as those produced by a compiler, and as well as high-level language code that can be executed by a computer using an interpreter etc. The hardware devices may be configured to operate as one or more software modules to perform the operations of the embodiments, and the reverse is also the same.

As described above, the embodiments have been described with reference to the limited embodiments and drawings.

If person who has ordinary knowledge in the technical field various modifications and variations are possible from the above mentions. For example, even if the described techniques are performed in a different order than the described method and/or components of described systems, structures, devices and circuit etc. may be united or combined with described methods and the other forms, or substituted or replaced by other components or equivalents, it can be appropriate results may be achieved.

Therefore, other implementations, other embodiments and equivalents to the claim range of the patent are also within the scope of the claims which are described later.

On the other hand, a sound-absorbing layer can be applied to the inner surface of the outer case of the management server (10).

A needle punch felt may be used, as the felt constituting the sound-absorbing layer,

The types of fibers constituting the sound-absorbing layer made of needle punch felt are polyester fibers, nylon fibers, polypropylene fibers, acrylic fibers, and natural fibers.

The thickness of the sound-absorbing layer is preferably 0.5 to 16 mm. If the thickness of the sound-absorbing layer is less than 0.5 mm, a sufficient sound-absorbing effect cannot be obtained. If the thickness is more than 16 mm, the space inside of the outer case of the management server (10) is reduced, and the space inside of the outer case of the management server (10) cannot be sufficiently obtained.

The weight of the sound-absorbing layer is preferably 5 to 500 g/m2. If the value is less than 5 g/m2, a sufficient sound-absorbing effect cannot be obtained. If it the value is more than 500 g/m2, the lightness of the outer case of the management server (10) cannot be ensured.

The fineness of the fibers constituting the sound-absorbing layer is preferably in the range of 0.1 to 20 decitex. At less than 0.1 decitex, the fineness of the fibers is not preferable because the absorption of low frequency noises is difficult and the cushioning property is lowered. If the fineness of the fiber exceeds 20 decitex, it is not preferable to absorb high frequency noise. The fineness of the fibers constituting the sound-absorbing layer is optimally in the range of 0.1 to 15 decitex.

When operation of the management server (10), noise can be reduced because the sound-absorbing layer is provided inside the outer case of the management server (10).

The Composition for anti-contamination application is formed on Anti-contamination application layer in order to effectively the prevent adhesion of contaminants and remove on the surface of the control unit (190). The composition for anti-contamination application contains sodium hydroxide and alkyl betaine, and the total content of sodium hydroxide and alkyl betaine is 1 to 10% weight among the total aqueous solution.

The sodium hydroxide and alkyl betaine are preferably used in an amount of 1 to 10% by weight among the aqueous solution of the total composition. When the content is less than 1% by weight, the coating property of the base material is deteriorated. When the content is more than 10% by weight, crystal precipitation tends to occur due to an increase in the coating film thickness.

A method of applying the present anti-contamination coating composition onto the control unit (190) is preferable coat of a spray method. In addition, the thickness of the final coated film on the control unit (190) is preferably 500 to 2000 Å, more preferably 1000 to 2000 Å. If the thickness of the coating film is less than 500 Å, there is a problem that it deteriorates in the case of high temperature heat treatment. And if it exceeds 2000 Å, there is a disadvantage that crystal deposition on the coated surface tends to occur.

1. The online open delivery system includes the following;
The online open delivery system for delivering goods of an online shopping mall through a delivery company selected by orderer, and provides information of a plurality of online shopping malls and Delivery Company registered as members through a website, and provides the address information (Hereinafter, delivery zone information), of the domestic or foreign countries registered by the delivery company and the delivery charge information, the delivery methods information and the point information according to the delivery zone information in the website, and the delivery management server for delivering a product purchased at a specific online shopping mall by an orderer (a company or an individual) to a delivery address through a delivery company selected by an administrator or seller in the online shopping mall; and performs goods selection in any one among a plurality of online shopping malls provided by the delivery management server, delivery methods selection provided by the delivery management server and the purchase payment or delivery payment for the goods or delivery company, and orderer terminal as terminal used by the orderer selects and inputs delivery address information for delivering a goods from the selected delivery company on the basis of the delivery zone information;

2. In the claim 1, Online open delivery system includes;
The delivery company server as server operated or managed by a delivery company sign up as a member on the delivery management server, and provide the information of delivery fee, delivery method and point according to the information of delivery company and delivery zone linked to a website or online shopping mall, and delivers the product purchased by the orderer to the input destination; and the shopping mall management server as server operated or managed by an administrator of the online shopping mall join as a member after connecting to the delivery management server, and provide online shopping mall information and product information linked to the web site.

3. In the claim 2, Online open delivery system includes;
The delivery management server interlocks with the online shopping mall provides a payment interface to performs all purchase payment of goods and delivery payment of delivery selected by orderer, or only delivery payment, and performs the delivery payment to finally calculate the delivery charge compare the first delivery charge to the second delivery charge calculated by the delivery company server after the first delivery charge is automatically calculated based on the delivery information inputted by the orderer when paying delivery payment.

4. In the claim 3, Online open delivery system includes;
The delivery company server collect and deliver the delivery product in association with first collecting terminal for collecting delivery goods on the move, second collecting terminal for collecting the delivery goods without moving, first delivery terminal for delivering a delivery goods on the move and second delivery terminal for delivering a delivery goods without moving calculate the first delivery charge automatically based on the weight and volume information of the goods and the delivery address information included the delivery information, and can provide to the delivery company server after the measured weight and volume information of the delivery goods is set as the second delivery charge by any one among the first collecting terminal, the second collecting terminal, the first delivery terminal, and the second delivery terminal

5. In the claim 2, The delivery management server of online open delivery system may include the following units;
member registration unit in which a plurality of online shopping malls and delivery companies are registered as members;
website mediating unit which provide the online shopping mall to orderer terminal;
information input unit in which is inputted information of goods selection, delivery methods' selection, purchase payment, delivery payment, and delivery address selection in the orderer terminal, and selected delivery company by seller or administrator in the online shopping mall;
delivery address database which is stored delivery zone information entered by delivery company and the delivery rate information and delivery method information according to the delivery zone information;
mediating unit of goods purchase which mediate information of goods selection and purchase payment input by orderer terminal between the online shopping mall and orderer terminal;
mediating unit of goods delivery which mediate information of delivery method selection and delivery charge payment input by orderer terminal between the website and delivery company server;
payment agency unit for providing a payment interface to perform both the purchase payment for the goods payment and the delivery payment for the delivery selected by the orderer terminal, or perform only payment for delivery;
providing unit of delivery information for providing the order information, delivery information, delivery charge information, and delivery status information; and
control unit for controlling the operation of each component constituting the delivery management server.

6. In the claim 5, the delivery management server of online open delivery system may include the following unit;
providing unit of price information that lists information of delivery methods and delivery charge according to the delivery address information inputted by the orderer, or provides it to the web page after adds each the goods (price) and the delivery charge among the goods information registered by shopping mall operations server, and the delivery zone information registered by the delivery company server.

7. In the claim 5, the delivery management server of online open delivery system may include the following;
the delivery management server may share information of seller and buyer with shopping mall operations server in the online shopping mall, and not be shared with the delivery company server.
